(19) United States
(12) Patent Application Publication
(10) Pub. No.: US 2009/0328104 A1
(43) Pub. Date: Dec. 31, 2009

(54) METHODS, SYSTEMS, AND COMPUTER PRODUCTS FOR PERSONALIZED CHANNEL SERVICES

(75) Inventors: Ann Taylor Jones, Atlanta, GA (US); Timothy H. Weaver, Alpharetta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 12/146,693

(22) Filed: Jun. 26, 2008

(51) Int. Cl. G06F 3/00

(52) U.S. Cl. 725/46

(57) ABSTRACT

Methods, systems, and computer program products for personalized media service. A programming preferences questionnaire is submitted to a user, and selections to the programming preferences questionnaire input by the user are received. Expected satisfaction values to available programs are assigned in accordance with selections input by the user, and programs in accordance with the assigned expected satisfaction values of the programs are selected. A combination of selected programs is provided to the user.

### BACKGROUND

The present invention relates generally to television (TV) channels, and more particularly to creating personalized channels.

Consumers today are faced with a constantly increasing number of choices when it comes to deciding what they will watch on TV. Advances in digital video transmission technologies have made it possible for service providers to deliver much more programming over the various types of distribution networks. Advances in digital video production technologies have reduced the cost and time required to create new video content making it economically and practically feasible to produce much more video media than ever before. Internet technologies are making it practical for service providers to deliver video media produced anywhere in the world to consumers, who just a few years ago, had access only to local and national media. Recording technologies have made it possible to distribute media to different consumers at different times. Taken together, these factors have potential to significantly improve the consumer TV experience, but the huge array of choices raises new challenges.

Historically, the TV “channel” has provided the organizing framework for media distribution reflecting the technical capabilities of traditional broadcast distribution networks. Using the channel concept, programmers seek to optimize the viewing experience by organizing the media in a way that best meets the viewing needs of mass audiences. When choosing the media to deliver and the timing of distribution, programmers consider many factors and use “averaged” information about the mass audiences as a foundation. While meeting the needs of the “average” consumer, this approach does not optimally satisfy the needs of individuals whose interests, work schedule, lifestyle, etc. are, in one or more ways, not aligned with the “average”. As technology advances increased the amount of bandwidth available on distribution networks, programmers responded by introducing more channels to better meet the needs of special interest market segments. As a result, consumers today are offered over 300 broadcast channels together with thousands of hours of on demand media

The broadcast programming choices are presented to customers in grids with hundreds of lines and columns. The on demand choices are presented to consumers in catalogs containing hundreds, (soon to be thousands) of titles. The task of finding the “best” programming to watch using the grids and catalog listing has become a complex and time consuming part of the viewing experience.

There is, therefore, a need for a better way to enable consumers to get the most from their TV viewing experience and to take full advantage of the ever-expanding array of choices offered by advanced media distribution technologies.

### BRIEF SUMMARY

Exemplary embodiments include a method of providing personalized media service, including submitting a programming preferences questionnaire to a user, receiving selections to the programming preferences questionnaire input by the user, and assigning expected satisfaction values to available programs in accordance with selections input by the user. The method also includes selecting programs in accordance with the assigned expected satisfaction values of the programs, and providing a combination of selected programs to the user.

Additional exemplary embodiments include a system of providing personalized media service, including an expected satisfaction values module that calculates expected satisfaction values for available programs and assigns an expected satisfaction value to each one of the programs, in accordance with selections input by a user for a programming preferences questionnaire. The system also includes a program scheduling module that selects programs in accordance with the assigned expectation values of the programs.

Further, exemplary embodiments include a computer program product, tangibly embodied on a computer readable medium, for allowing access to personalized media services over an Internet Protocol based network. The computer program product has instructions for causing a computer to execute a method, which includes submitting a programming preferences questionnaire to a user, receiving selections to the programming preferences questionnaire input by the user, assigning expected satisfaction values to available programs in accordance with selections input by the user, selecting programs in accordance with the assigned expected satisfaction values of the programs, and providing a combination of selected programs to the user.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGs.:

FIG. 1 illustrates a block diagram of an exemplary network/system;

FIG. 2 illustrates a flow chart of a media (personalized channel) services method in accordance with exemplary embodiments;

FIG. 3 illustrates a flow chart of providing a media (personalized channel) services method in accordance with exemplary embodiments; and

FIG. 4 illustrates a block diagram of a media (personalized channel) services system in accordance with exemplary embodiments.

The detailed description explains the exemplary embodiments, together with advantages and features, by way of example with reference to the drawings.

### DETAILED DESCRIPTION OF EXEMPLARY EMBODIMENTS

Exemplary embodiments illustrate services that identify programming available at any given time that may be attractive to a consumer based on individual consumer preferences and develop a personalized channel (e.g., “My Channel”) containing the programming that maximizes the customer's expected satisfaction.

In exemplary embodiments, a customer may tune into the personalized channel (“My Channel”) as they would tune to any other channel and is presented with a full schedule of programs constructed from programs on various channels. The customer can watch the personalized channel continuously without changing channels and be confident he/she is seeing the programs that best match his/her interests and preferences. Individuals within a customer's household might elect to create more than one personalized channel to reflect the different interests and preferences of individual family members. For example, a personalized channel might be created for a young child in the household featuring age appropriate programming. Similarly, an individual in the household might elect to create more than one personalized channel for himself to reflect different “moods”.

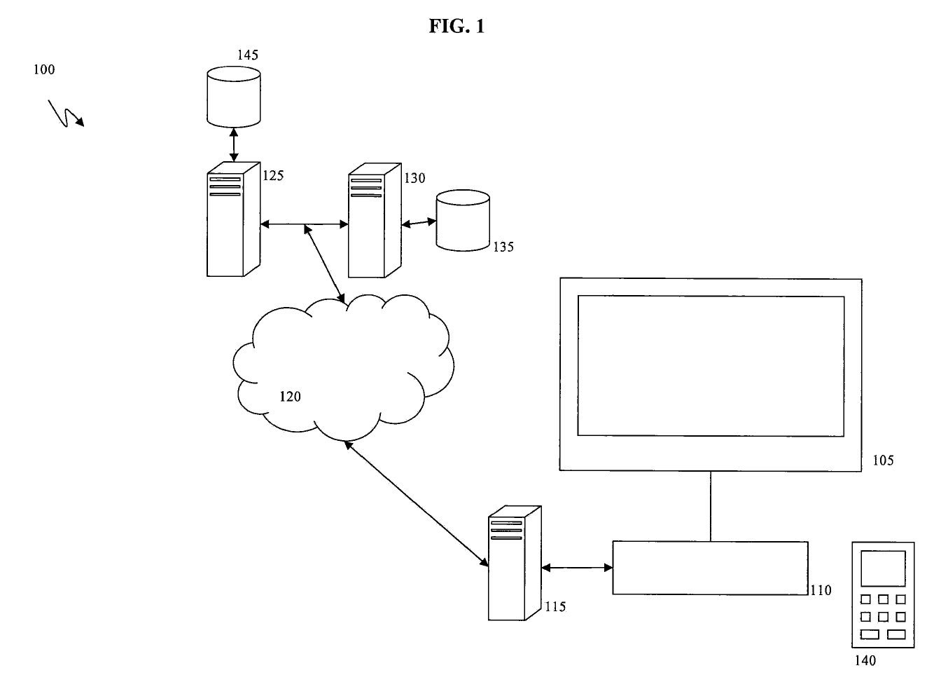

FIG. 1 illustrates a block diagram of an exemplary network/system 100. The network/system 100 provides an infrastructure through which users can access media (e.g., programming content) through a communications device 105, such as an IPTV-enabled television and a set top box 110 configuration. It is understood that in exemplary embodiments and implementations, the communications device 105 can be a variety of other communications devices such as, but not limited to, general purpose or laptop computers, wireless devices such as cellular telephones, portable computing device, and digital music players (e.g., MP3 players). In addition, a wireline PSTN telephone, SIP telephone, dual-mode mobile telephone, personal digital assistant (PDA), or other type of communications device may be included in the network/system 100 of FIG. 1.

The network/system 100 can manage multiple accounts (i.e., personalized channels) as established by particular users. These accounts may then be used to provide access to media services as described further herein. As an IPTV network, the network/system 100 may also include a remote controller 140 for inputting information and controlling the communications device 105 (e.g., an IPTV) and/or the set top box 110.

According to exemplary embodiments, the network/system 100 includes the communications device 105 as discussed above, which can be a IPTV enabled television communicatively coupled to the set top box 110, which may in turn be communicatively coupled to a server 115 for accessing a network 120, such as the Internet. The network 120 may include circuit-switched and/or packet-switched technologies and devices, such as routers, switches, hubs, gateways (e.g., residential gateways, including a DSL modem), and IMS-based network, for facilitating communications between the communications device 105 and an authentication server 130. The network 120 may include wireline and/or wireless components utilizing, e.g., 802.11 standards for providing over-the-air transmissions of communications. The network 120 can be an IP-based network for communication between a customer service center and clients (customers), as discussed further below, using the communication devices 105 via a broadband connection. According to exemplary embodiments, the network 120 transmits media (programming content) from content services provider systems to customers via devices, such as the communications device 105, through a broadband connection. In exemplary embodiments, the network 120 can be a managed IP network administered by a service provider, which can control bandwidth and quality of service for the communications discussed herein. The network 120 may be implemented in a wireless fashion, e.g., using wireless protocols and technologies, such as WiFi, WiMax, etc. The network 120 can also be a packet-switched network as a local area network, wide area network, metropolitan area network, Internet network, or other similar type of network environment. The network 120 may be a cellular communications network, a fixed wireless network, a wireless local area network (LAN), a wireless wide area network (WAN) a personal area network (PAN), a virtual private network (VPN), intranet or other suitable network system and includes equipment for receiving and transmitting signals such as a cell tower and mobile switching center. In other exemplary embodiments, the network 120 can be a circuit-switched network such as a standard public switched telephone network (PSTN).

As further shown in FIG. 1, a host server 125 is in communication with the authentication server 130 and communications device 105 via the network 120. The host (media) server 125 may be implemented using a high-speed processing device (e.g., a computer system) that is capable of handling high volume activities conducted via the communications device 105 and other network entities (e.g., the authentication server 130). The host server 125 may be implemented by a network service provider, a content service provider, a media provider, or another enterprise. Similarly, the authentication server 130 may be implemented using a high-speed processing device (e.g., a computer system) that is capable of handling high volume activities conducted via the communications device 105 and other network entities (e.g., server 115) via the network 120. According to exemplary embodiments, the authentication server 130 receives requests from the communications device 105 either to establish a media services (e.g., a personalized channel) account or to access network services (e.g., to access media). The authentication server 130 may implement authentication software for restricting or controlling access to (media) network services provided by the host server 125. The authentication server 130 may be in communication with a customer identity system (CIS) database 135, which stores user credentials (e.g., user names and passwords). In other exemplary embodiments, user credentials can be stored on the communications device 105.

As discussed above, the communications device 105 may be an Internet Protocol-enabled television (IPTV). In exemplary embodiments, the user can establish an account using devices associated with the user. For example, the communications device 105 can enable the establishment of an account, such as a media services account, that is managed by the provider enterprise of the host server 125. As such, the communications device 105 may receive Internet services from the provider enterprise of the host server 125. An account record may be generated for the user of the communications device 105 that identifies the user and the account for which the services are provided. Account information and records may be stored in a storage device accessible by the host server 125, such as a storage device 145.

In exemplary embodiments, the communications device 105 is owned/operated by one or more individuals that share some relationship (e.g., members of a household). The host server 125 may implement one or more applications for establishing and utilizing a media service account (e.g., a personalized channel). The media service account can be stored in the storage device 145. A media service account (e.g., personalized channels) may be created for multiple users via the communications device 105. Therefore, a user can configure or otherwise establish preferences for his or her personalized channel.

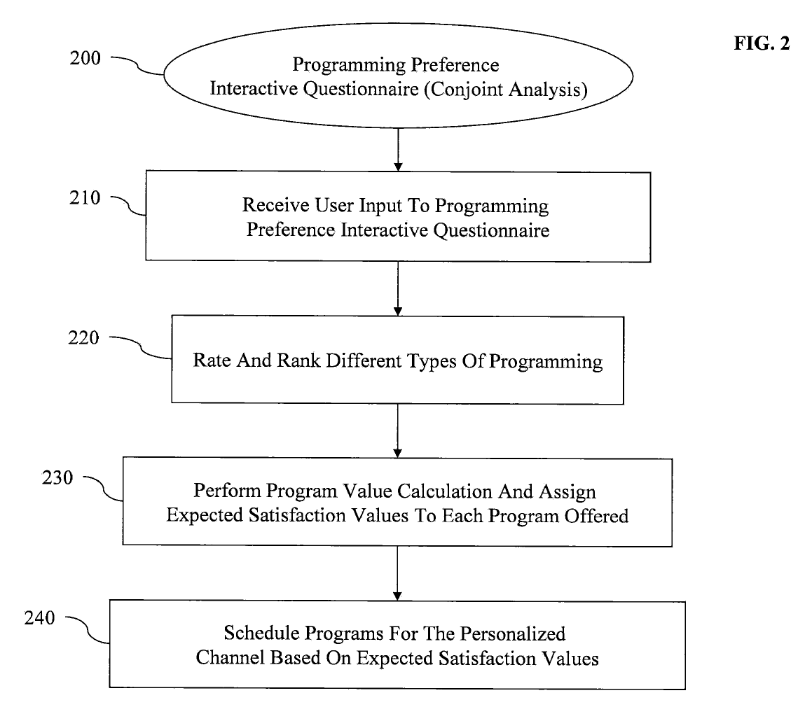

FIG. 2 illustrates a flow chart of a media services method for a personalized channel in accordance with exemplary embodiments. In advance, a programming preference interactive questionnaire (conjoint analysis) is completed by the user and answers/selections to the questionnaire are received at 200. Since the questionnaire is interactive, the questions of the programming preference interactive questionnaire may adapt according to the answers/selections input by the user.

Based on the programming preference interactive questionnaire, user preferences are established for different types of programming at 210. Interest attributes are extracted from the responses/selections to the questionnaire.

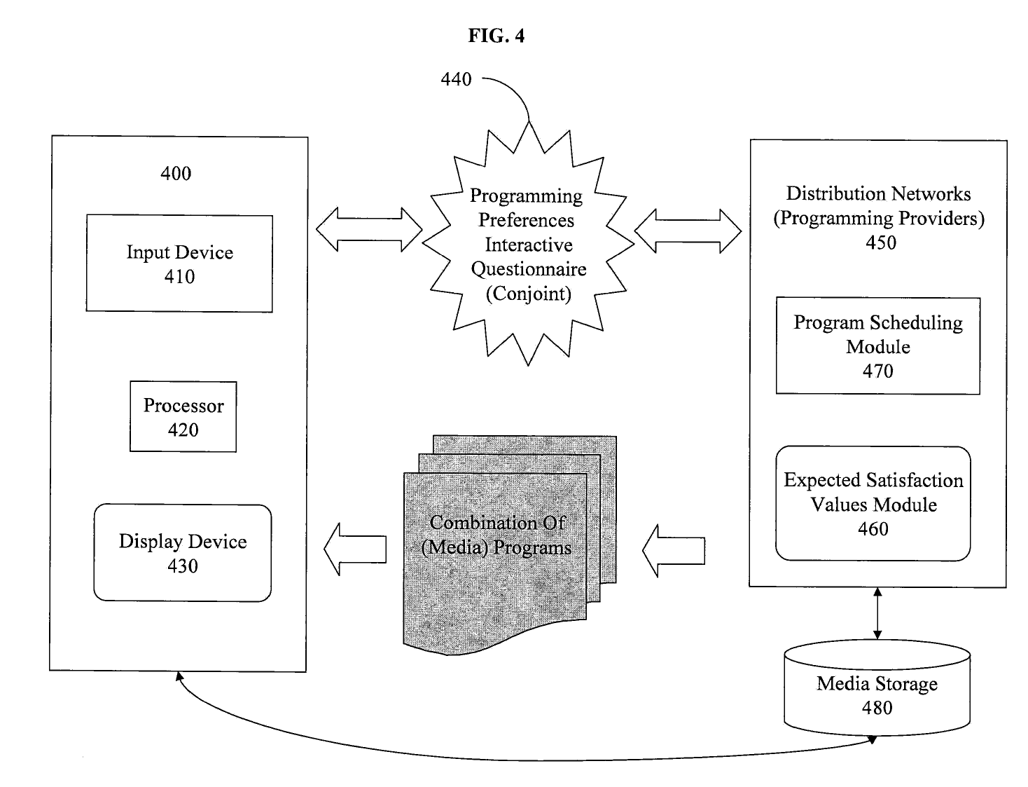

The different types of programming are rated and ranked at 220 according to the user's responses to the questionnaire. A program value calculation is performed, and expected satisfaction values are assigned to each program being offered at 230. As a non-limiting example, there are numerous programming being offered at the same time, on the same day, throughout the week, and the expected satisfaction values are assigned to such programming by, e.g., an expected satisfaction values module 460 in FIG. 4.

A combination of programs are scheduled (by a program scheduling module 470 in FIG. 4) for the personalized channel (e.g., “My Channel”) utilizing the expected satisfaction values assigned to each program, such that a sequentially arranged schedule of programs achieves a highest overall expected satisfaction value at 240. The highest overall expected satisfaction value is in accordance with the selections/answers input to the questionnaire by the user. Also, the highest overall satisfaction value is achieved by summing together the assigned expected satisfaction values for the selected programs, such that the summation of assigned expected satisfaction values add up to the highest total. In exemplary embodiments, different sequential combinations of programs may be considered and summed to determine the total satisfaction value of each combination, and then the combination with the highest satisfaction may be selected. Programs may be substituted and/or arranged to achieve the highest overall satisfaction value. In a non-limiting example, on weekdays, an individual may prefer to watch news and weather in the morning and sports in the evening, and on weekends, the individual may prefer to watch dramas. The sequentially arranged schedule of programs achieves a highest overall expected satisfaction value in accordance with selections input by the user.

Moreover, as a non-limiting example, a personalized channel may be created by first assigning an expected satisfaction value to each program available at a particular time of day and then selecting programs with the highest expected satisfaction values to be included in the personalized channel (“My Channel”) at each time of day. Providing programs on “My Channel,” however, is not limited to the time of day that the programs are currently being aired (in the traditional sense), and programs may be stored/recorded for later presentation on “My Channel.” The stored/recorded programs may be incorporated into the sequentially arranged schedule of programming for the personalized channel such that the highest overall expected satisfaction value is achieved, regardless of the time of day the programs were initially aired.

Further, regarding the questionnaire, individuals in the household may answer a series of questions contained in a (conjoint analysis) programming preferences interactive questionnaire designed to identify preferences for different types of programming including the importance placed on the attributes and the relative “value” associated with various programming attributes. The programming preferences interactive questionnaire may use discrete choice methodology or other similar methodology for determining the relative value of specific attributes of a specific individual. According to exemplary embodiments, individuals in the household have the ability to change answers to the questionnaire whenever they desire, which may result in a different combination of programs scheduled for “My Channel”.

With regard to providing a personalized channel of interest to the user, specific attributes associated with each program are accessed. For example, some general interest attributes might include: Type: movie, TV series, and/or documentary; Genre: comedy, romance, and/or action; Ratings: G, PG, R, and/or MA. Based on the user's preferences, certain programs may provide a high or low expected satisfaction value.

In non-limiting examples, the questionnaire includes a conjoint analysis, which is a process that allows a subset of the possible combinations of product features (which may be specific attributes of the programming) to be used to determine the relative importance of each feature of the programming content. The conjoint analysis is based on the fact that the relative values of programming attributes considered jointly can better be measured than when considered in isolation.

In non-limiting examples, an individual may be asked to arrange a list of combinations of programming attributes in decreasing order of preference. Once this ranking is obtained, a process is used to find the utilities of different values of each attribute that result in the individual's order of preference. Since the utilities can be determined using a subset of possible programming attribute combinations, it may or may not be necessary to present every possible combination of programming attributes to the individual. From these results, the desirability of the programming combinations that were not tested can be predicted. Also, the conjoint analysis may include a regression analysis, a choice based analysis, and/or a discrete choice analysis.

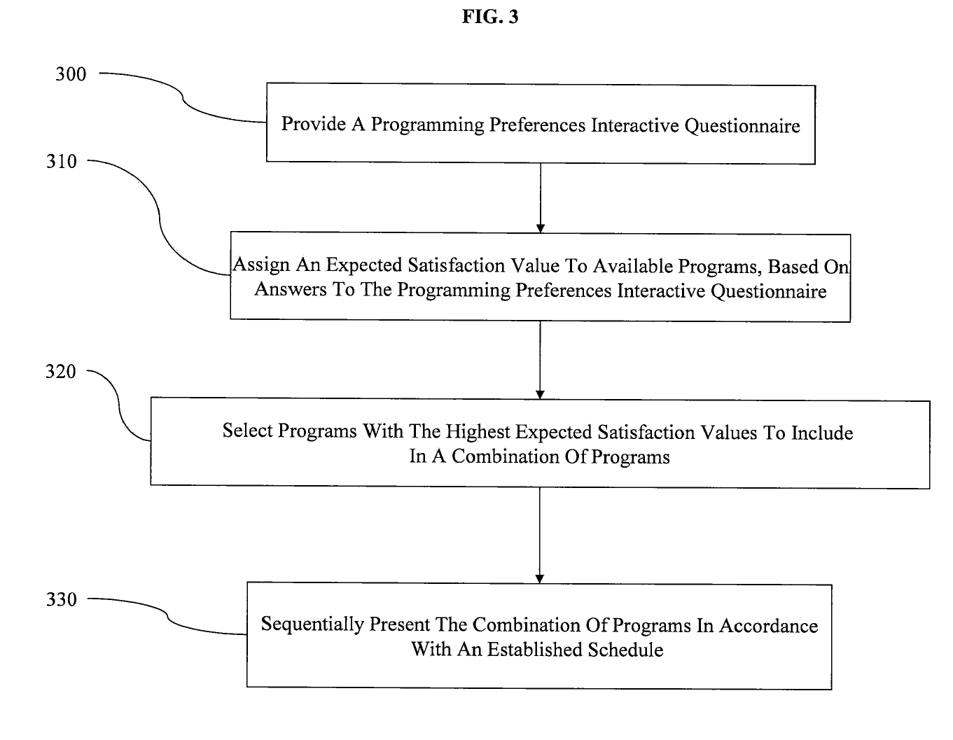

FIG. 3 illustrates a flow chart of providing a media (personal channel) services method in accordance with exemplary embodiments. A programming preference interactive questionnaire is provided to a user, which allows the user to make interactive selections/responses at 300. The questionnaire may be provided by the set top box 110, a distribution network 450, and/or a service provider. Based on answers/selections to the programming preference interactive questionnaire, expected satisfaction values are assigned (by expected satisfaction values module 460) to available programs at 310. In accordance with exemplary embodiments, the questionnaire may be stored on the set top box 110, on the host server 125 and/or in the storage 145. If available programs have the same or similar expected satisfaction values, the program(s) having a lower expected satisfaction value may be stored/recorded for later. The process (or service provider or the set top box 110) selects programs with the highest expected satisfaction values to include in a combination of programs at 320. The combination of programs is sequentially presented to the user in accordance with an established schedule at 330. The user may tune in to “My Channel” and watch programs that suit his/her interests.

In accordance with exemplary embodiments, the set top box 110 may tune into various channels according to the scheduled combination of programs. In accordance with exemplary embodiments, an application in the set top box 110 maps to the various channels having the scheduled combination of programs, such that the set top box 110 tunes into the designated channel in accordance with the combination of programs. Conversely, the content (distribution) provider provides a play list for the personalized channel. The content provider may have an application or module that maps to the various channels, such that the scheduled combination of programs is presented to the user on the personalized channel.

FIG. 4 illustrates a block diagram of a media (personal channel) services system 400 in accordance with exemplary embodiments. The media system 400 includes an input device 410 (e.g., a remote control), a processor 420, and a display device 430. The user makes selections and controls the media system 400 with the input device 410, according to exemplary embodiments. The input device 410 may be used to answer the programming preferences interactive questionnaire 440 provided by a distribution (e.g., TV) network 450 (e.g., the personal channel service provider). As a non-limiting example, the programming preferences interactive questionnaire 440 may be provided via the set top box 110 or stored on the set top box 110. Since the questionnaire 440 is interactive, the user may continuously make selections via the input device 410 until all necessary information is acquired. The processor 420 controls the processes of the media system 400.

The distribution network 450 includes an expected satisfaction values module 460. According to exemplary embodiments, the expected satisfaction values module 460 has a program value calculation process that is used to assign expected satisfaction values to each program using the program attributes and the customer preferences. The expected satisfaction values module 460 may also calculate and assign expected satisfaction values to each program in accordance with the particular time at which the programs are being offered.

The distribution (TV) network 450 includes a program scheduling module 470. According to exemplary embodiments, the program scheduling module 470 has a program scheduling process that uses the expected satisfaction values assigned to each program, by the expected satisfaction module 460, to identify a combination of programs that can be presented sequentially to achieve the highest overall expected satisfaction value for the day, hour, week, etc. Therefore, the program scheduling module 470 may compile a complete schedule of programming for the user. Additionally, the combination of programs presented sequentially is not limited to the time of day in which the programs are being aired. Programs may be recorded/stored in a media storage 480 and presented/inserted in the combination of programs such that the highest overall satisfaction value is achieved.

When a customer selects the personalized channel (e.g., “My Channel”), the media system 400 may be automatically set (tuned) to the channel (“My Channel”) containing the selected programs in accordance with an established schedule. From the user's perspective, “My Channel” shows the desired programs (media) on display device 430 whenever the user selects “My Channel.”

In accordance with exemplary embodiments, the combination of programs may be collected/transmitted by the distribution (TV) network 450 such that the programs are displayed on “My Channel”. In accordance with exemplary embodiments, the set top box 110 may tune and/or be set to the various channels airing the scheduled programs and present them on “My Channel” in accordance with the sequentially scheduled combination of programs. As such, the set top box 110 may change channels so that the appropriate program is presented to the customer on the personalized channel in accordance with the sequentially scheduled combination of programs. The medium through which “My Channel” is provided is not limited and may include an Internet Protocol based network, satellite system, cable system, telephone system, gaming system, etc., and any combination thereof.

The process in which the user answers and/or receives questions of the programming preferences interactive questionnaire 440, as discussed herein, is not meant to be limiting. Answers and/or questions to the questionnaire 440 may be transmitted/received between the media system 400 and the distribution networks 450, or the user may interact with the set top box 110 when transmitting answers and/or receiving questions of the questionnaire 440. Also, the user may make selections for the questionnaire 440 in advance, for example, online at a personal channel website. Indeed, the user is not limited to any particular way or medium for completing the questionnaire 440, and the user may provide answers in a hard copy or soft copy form. Furthermore, the user may complete the questionnaire 440 via telephone, PDA, mobile device, computer, etc.

“My Channel” (personal channel) service may include advertising messages that are specifically selected to be of interest to the individual based on the customer profile (e.g., responses to the questionnaire 440). In this case, the advertising messages are integrated into the schedule like any other programming element such that the advertising messages are presented that best fit the customer's needs and interests.

Further, “My Channel” service may include “paid” programming (e.g., On Demand™) in the list of programs, which are considered for presentation in any time period. In this case, if the expected satisfaction value is below a predetermined threshold that may be stored in storage 135, 145 and may be set in advance by the user or service provider, the program scheduling module 470 scans for paid programming that will increase the (overall) expected satisfaction value. The paid programming is then included in the combination of programs sequentially presented on “My Channel”.

As discussed above, “My Channel” service may include programming recorded/stored locally on the media storage 480 (e.g., a DVR device) in the list of programs that are considered for presentation. As a non-limiting example, if the expected satisfaction value is below a predetermined threshold, the program scheduling module 470 may use locally stored programming that increases the expected satisfaction value. As a non-limiting example, the program scheduling module 470 may choose locally stored/recorded programming to schedule for a particular time slot in the list of programs, to replace a previously scheduled program that is below a preset threshold, and/or to increase the overall expected satisfaction value.

Also, in accordance with exemplary embodiments, “My Channel” service provides the customer with options when more than one program is available at a particular time, and the programs provide equal or very similar expected satisfaction values. In this case, at the scheduled time, the user is presented with a list of the combination of sequentially scheduled programs) of programs selected for presentation on the customer's personal channel. In this case, the list can be viewed on the communications device 105, such as a TV, personal computer (PC), or mobile device. When using the planning feature, customers can pre-select programs when options are presented and those selections are saved as part of their personal channel schedule, according to exemplary embodiments. In addition, a customer may indicate that he/she programming containing one or more viewing choices from which the user selects the one program he/she desires to watch. The other programs not selected by the user may be stored/recorded in the media storage 480 and presented at later times and/or on other days.

Further, “My Channel” service may provide the customer with a planning feature such that the customer may browse a list (i.e., does not want to watch a program selected for a particular period, in which case, another program available at that time having an attractive expected satisfaction value will be put in its place.

“My Channel” service may also provide customers with the capability to share their personalized channel schedule (i.e., watch “My Channel”). To accomplish this, the customer may “publish” his/her “My Channel” so that the list of programs included in the personal channel can be selected and used by the universe of service users or by a specific subgroup of users. When “publishing” his/her personal channel, a user may have the capability to provide identifying and descriptive information about the personal channel, which includes the content, age appropriateness of the material, genre, annotations, etc.

In addition, the “My Channel” service allows customers to efficiently share their responses/selections to the programming preferences interactive questionnaire 440 that have resulted in development of schedules that are particularly satisfying to them, and the same might be satisfying to others they know, according to exemplary embodiments. In this case, the recipient can use the questionnaire responses to develop his/her own personalized channel and/or to modify any responses if desired.

The “My Channel” service may provide customers with a “My Channel” guide that they can use to display information about each of the programs included on their “My Channel” schedule. According to exemplary embodiments, among the information to be included in the “My Channel” guide is the name of the program, description of the program, program artists, program ratings, and expected satisfaction value score for each program. Customers may browse their schedule and view the program information using the TV, a PC, a mobile device, etc.

Exemplary embodiments of “My Channel” service are not limited to traditional means of transmission. As a non-limiting example, access to “My Channel” service may be via Internet Protocol (IP) TV, satellite, cable, telephone lines, and/or any combination thereof. Further, the terms “My Channel” are not meant to be limiting, but are representative of a personalized channel or personalized media service.

Furthermore, exemplary embodiments are not limited to but are capable of being implemented in the network/system illustrated in FIG. 1. Additionally, the servers 115, 125, and 130 may be representative of numerous servers. The storages 135 and 145, may be representative of numerous storages. Likewise, the network 120 may be representative of numerous networks and systems. Therefore, the network/system 100 illustrated in FIG. 1 is neither limited numerically to the elements depicted therein nor limited to the exact configuration of elements. It is understood by those skilled in the art that elements may be added to, subtracted from, or substituted for the elements described in the network/system 100 of FIG. 1.

As described above, exemplary embodiments can be in the form of computer-implemented processes and apparatuses for practicing those processes. Exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. Exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the present disclosure has been described with reference to exemplary embodiments, it will be understood by those skilled in the art that various changes may be made and equivalents may be substituted for elements thereof without departing from the scope. In addition, many modifications may be made to adapt a particular situation or material to the teachings of the present disclosure without departing from the essential scope thereof. Therefore, it is intended that the present disclosure not be limited to the particular exemplary embodiments disclosed for carrying out this invention, but that the present disclosure will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of providing personalized media service, comprising:
submitting a programming preferences questionnaire to a user;
receiving selections to the programming preferences questionnaire input by the user;
assigning expected satisfaction values to available programs in accordance with the selections input by the user;
selecting programs from the available programs in accordance with the assigned expected satisfaction values of the programs; and
providing a combination of the selected programs to the user.

2. The method of claim 1, wherein the programming preference questionnaire is interactive and the questions being presented in the programming preference questionnaire adapt based on selections input by the user.

3. The method of claim 1, wherein selecting programs from the available programs in accordance with the assigned expected satisfaction values of the programs comprises selecting the programs to achieve a highest overall expected satisfaction value based on a summation of the assigned expectation values for the selected programs, in accordance with the selections input by the user.

4. The method of claim 1, wherein providing the combination of the selected programs to the user comprises providing a sequentially scheduled arrangement of programs to the user in accordance with assigned expectation values of the programs.

5. The method of claim 4, wherein the sequentially scheduled arrangement of programs achieves a highest total of expected satisfaction value based on a summation of the assigned expected satisfaction values for the selected programs.

6. The method of claim 1, further comprising:
determining attributes of interest to the user in accordance with the selections input by the user to the programming preferences questionnaire; and
calculating the expected satisfaction values for the available programs.

7. The method of claim 1, wherein the combination of programs are sequentially provided to the user on a personalized channel.

8. The method of claim 7, wherein a list of the selected programs is provided to the user on the personalized channel such that the user can browse the list of selected programs in advance, and
wherein the list of the selected programs enables the user to make deletions and additions to the selected programs in the list.

9. The method of claim 1, wherein each of the selected programs is placed in a time slot such that the combination of selected programs is presented sequentially to the user on a personalized channel.

10. The method of claim 1, further comprising:
if at least two of the available programs have similar expected satisfaction values, storing the available program having the lower expected satisfaction value and presenting the available program having the higher expected satisfaction value in the combination of selected programs.

11. A system of providing personalized media service, comprising:
an expected satisfaction values module that calculates expected satisfaction values for available programs and assigns an expected satisfaction value to each of the available programs, in accordance with selections input by a user for a programming preferences questionnaire; and
a program scheduling module that selects programs from the available programs in accordance with the assigned expectation values of the programs.

12. The system of claim 11, wherein the program scheduling module selects the programs from the available programs to achieve a highest total expected satisfaction value based on a summation of the assigned expectation values of the programs, and
wherein the program scheduling module provides a sequentially scheduled arrangement of the selected programs to a personalized channel.

13. The system of claim 11, wherein the programming preferences interactive questionnaire adapts based on selections input via an input device by the user.

14. The system of claim 11, wherein:
the expected satisfaction values module extracts interest attributes from the selections input to the programming preferences questionnaire, the extracted interest attributes being employed by the expected satisfaction values module in the calculation of expected satisfaction values for different types of programs, and
the program scheduling module compiles the selected programs to be sequentially presented on a personalized channel.

15. The system of claim 11, further comprising:
a media device configured to be set to a personalized channel, wherein the media device set to the personalized channel receives the programs selected by the program scheduling module.

16. The system of claim 11, wherein the programming preferences questionnaire is a conjoint analysis, such that interest attributes are extracted from the selections to the programming preferences questionnaire.

17. A computer program product, tangibly embodied on a computer readable medium, for allowing access to personalized media services over an Internet Protocol based network, the computer program product including instructions for causing a computer to execute a method, comprising:
submitting a programming preferences questionnaire to a user;
receiving selections to the programming preferences questionnaire input by the user;
assigning expected satisfaction values to available programs in accordance with the selections input by the user;
selecting programs from the available programs in accordance with the assigned expected satisfaction values of the programs; and
providing a combination of the selected programs to the user.

18. The computer program product of claim 17, wherein providing the combination of the selected programs to the user comprises providing a sequentially scheduled arrangement of programs to the user in accordance with assigned expectation values of the programs.

19. The computer program product of claim 17, further comprising:
determining attributes of interest to the user in accordance with the selections input by the user to the programming preferences questionnaire; and
calculating the expected satisfaction values for the available programs.

20. The computer program product of claim 17, wherein a list of the selected programs is provided to the user on the personalized channel such that the user can browse the list of selected programs in advance, and
wherein the list of the selected programs enables the user to make deletions and additions to the selected programs in the list.
